(19) United States
(12) Patent Application Publication
(10) Pub. No.: US 2008/0067883 A1
(43) Pub. Date: Mar. 20, 2008

(54) Generator and/or motor assembly

(76) Inventors: Peter D. Witt, Nesconsett, NY (US); David C. Reuter, Ann Arbor, MI (US); Oyvin Haugan, Hillsboro, OR (US); Ananta K. Gopalan, Hampton, NH (US)

Correspondence Address: PETER D. WITT, 11 REGINA CT., NESCONSETT, NY, 11767, US

(21) Appl. No.: 11/523,188

(22) Filed: Sep. 18, 2006

(51) Int. Cl. H02K 1/12; H02K 1/22; H02K 11/00; H02K 3/04

(52) U.S. Cl. 310/71; 310/179; 310/254; 310/261

(57) ABSTRACT

A generator and/or motor device that includes an inner stator having one or more inner coils, an outer stator shell having one or more outer coils, and a rotor assembly arranged radially between, and configured to rotate relative to, the inner stator and the outer stator shell. The rotor assembly has one or more outer magnetic elements adjacent to the outer coils and has one or more inner magnetic elements adjacent to the inner coils. An electromotive force may be generated in at least one of the inner and outer coils upon relative rotation of the rotor assembly. Alternatively, relative rotation of the rotor assembly may be caused upon an electromotive force being applied in at least one of the inner and outer coils. The rotor assembly may be attached to an input shaft. The rotor assembly includes a rotor spool to which the inner and outer magnetic elements are secured.

### FIELD OF THE INVENTION

The present invention relates to a generator and/or motor assembly.

### BACKGROUND INFORMATION

Electrical generators convert mechanical, e.g., rotational, energy to electricity. Conventional generators typically include a stator and a rotor. The stator has a frame and a winding. The frame has a conductive winding that is mounted in a frame around a longitudinally-defined inner space. The rotor includes a set of permanent magnets having north and south poles alternately mounted circumferentially on an armature. When the generator is assembled, the armature is rotatably mounted in the inner space in the stator, and the set of permanent magnets is positioned corresponding to the winding such that a gap exists between the set of permanent magnets and the winding. When the armature is coupled to a prime mover, such as a turbine, the turbine rotates the armature, and the set of permanent magnets is rotated by the armature relative to the winding in the stator. The rotating set of permanent magnets induces an electromotive force in the winding.

However, conventional arrangements of electrical generators may be bulky, inefficient and limited in their function.

### SUMMARY

Example embodiments of the present invention provide a device for generating power, e.g., an axial flux, permanent magnet coreless generator assembly. For example, the device may include an inner stator having one or more inner coils, an outer stator shell having one or more outer coils, and a rotor assembly arranged radially between and configured to rotate relative to the inner stator and the outer stator shell. The rotor assembly has one or more outer magnetic elements axially adjacent to the outer coils and has one or more inner magnetic elements adjacent to the inner coils, an electromotive force being generated in at least one of the inner and outer coils upon relative rotation of the rotor assembly. The rotor assembly may be attached to an input shaft. The rotor assembly includes a rotor spool to which the inner and outer magnetic elements are secured. The magnetic elements are secured to and extend radially outwardly from an outer circumferential surface of the rotor spool, and the outer coils are secured to and extend radially inwardly from an inner circumferential surface of the outer stator shell, such that the outer coils are arranged in spaces axially between the outer magnetic elements. Also, the inner magnetic elements are secured to and extend radially inwardly from an inner circumferential surface of the rotor spool, and the inner coils are secured to and extend radially outwardly from an outer circumferential surface of the inner stator, such that the inner coils are arranged in space axially between the inner magnetic elements.

The rotor assembly is supported relative to at least one of the outer stator shell and the inner stator by bearing assemblies. The bearing assemblies may support the rotor assembly relative to both of the outer stator shell and the inner stator. Also, the outer stator shell and the inner stator may include one or more passages for conveying lubrication, e.g., cooling oil for the bearings and/or the regions of the coil assemblies. The outer stator shell and the inner stator may also include terminal connections and a wire passage, such that wires from the respective inner and outer coil assemblies may extend through the passage to the terminal connection.

The outer magnetic elements and the outer coils may be employed as a generator, and the inner magnetic elements and the inner coils may be employed as other than a generator. For example, the inner magnetic elements and the inner coils may be arranged as a motor adapted to start the generator, e.g., by starting a prime mover coupled to the generator, to charge a battery in the electrical system that includes the generator, to power an accessory or accessories of the generator and/or other systems that include the generator, or as an alternator. The outer magnetic elements and the outer coils may be employed to generate power, and the inner magnetic elements and the inner coils may be employed to augment the power generated by the outer magnetic elements and the outer coils.

It should be appreciated that the magnetic elements may be arranged on the rotor or on the stator and that the coils may be arranged on the rotor or the stator as desired. Furthermore, the inner and/or outer magnetic elements and coils may be arranged in any combination on the rotor and stators.

Moreover, rotational motion may be applied to the rotor so that electricity is produced by relative rotation between the magnetic elements and the coils. It should be appreciated that electrical energy may be applied to the inner coils and/or the outer coils to produce rotational motion in the rotor. That is, the device may be arranged as motor rather than a generator.

According to an example embodiment of the present invention, a generator includes: a radially-inner stator including at least one radially-inner coil; a radially-outer stator including at least one radially-outer coil; and a rotor assembly arranged radially between the inner stator and the outer stator, the rotor rotatable relative to the inner stator and the outer stator, the rotor assembly including at least one radially-outer magnetic element adjacent to the outer coil and including at least one radially-inner magnetic element adjacent to the inner coil.

The rotor assembly may be attached to an input shaft.

Each outer coil may be arranged in space between outer magnetic elements, and each inner coil may be arranged in space between inner magnetic elements.

The rotor assembly may include a rotor spool, and each outer magnetic element may be secured to and extend radially outwardly from an outer circumferential surface of the rotor spool.

Each outer coil may be secured to and extend radially inwardly from an inner circumferential surface of the outer stator.

The rotor assembly may include a rotor spool, and each inner magnetic element may be secured to and extend radially inwardly from an inner circumferential surface of the rotor spool.

Each inner coil may be secured to and extend radially outwardly from an outer circumferential surface of the inner stator.

The rotor assembly may be supported relative to at least one of (a) the outer stator and (b) the inner stator by bearing assemblies.

At least one of (a) the outer stator and (b) the inner stator may include a passage adapted to convey a lubrication medium.

At least one of (a) the outer stator and (b) the inner stator may include a terminal connection and a passage, and wires from the coils may extend through the passage to the terminal connection.

The outer magnetic elements and the outer coils may be arranged for generation of electricity, and the inner magnetic elements and the inner coils may not be arranged for generation of electricity.

A first one of (a) the outer magnetic elements and the outer coils and (b) the inner magnetic elements and the inner coils may be arranged for generation of electricity, and a second one of (a) the outer magnetic elements and the outer coils and (b) the inner magnetic elements and the inner coils may be arranged as a motor.

According to an example embodiment of the present invention, a device includes: a radially-inner stator including at least one radially-inner coil; a radially-outer stator including at least one radially-outer coil; and a rotor assembly arranged radially between the inner stator and the outer stator, the rotor rotatable relative to the inner stator and the outer stator, the rotor assembly including at least one radially-outer magnetic element adjacent to the outer coil and including at least one radially-inner magnetic element adjacent to the inner coil. The inner magnetic elements and the inner coils are arranged as at least one of (a) a generator and (b) a motor, and the outer magnetic elements and the outer coils are arranged as at least one of (a) a generator and (b) a motor.

According to an example embodiment of the present invention, a motor includes: a radially-inner stator including at least one radially-inner coil; a radially-outer stator including at least one radially-outer coil; a rotor assembly arranged radially between the inner stator and the outer stator, the rotor assembly rotatable relative to the inner stator and the outer stator, the rotor assembly including at least one radially-outer magnetic element adjacent to the outer coil and at least one radially-inner magnetic element adjacent to the inner coil.

The rotor assembly may be attached to an input shaft.

Each outer coil may be arranged in space between outer magnetic elements, and each inner coil may be arranged in space between inner magnetic elements.

The rotor assembly may include a rotor spool, and each outer magnetic element may be secured to and extend radially outwardly from an outer circumferential surface of the rotor spool.

Each outer coil may be secured to and extend radially inwardly from an inner circumferential surface of the outer stator.

The rotor assembly may include a rotor spool, and each inner magnetic element may be secured to and extend radially inwardly from an inner circumferential surface of the rotor spool.

Each inner coil may be secured to and extend radially outwardly from an outer circumferential surface of the inner stator.

The rotor assembly may be supported relative to at least one of (a) the outer stator and (b) the inner stator by bearing assemblies.

It should be appreciated that the power output capacity and capabilities of the generator assembly may be scaled upwardly or downwardly by addition or removal of magnet/coil pairs from the stack. In addition, it should be appreciated that an input of the generator assembly may be connected to an output of, e.g., an internal combustion engine, e.g., of the barrel-type, which is sized and configured to operate most efficiently in a manner matched to the operating range of the generator assembly.

According to an example embodiment of the present invention, a coil arrangement is provided for at least one of (a) a generator and (b) a motor. The coil arrangement may include a plurality of windings, each winding including: circumferential portions that follow a substantially arcuate path; and radial portions that extend radially inwardly relative to the circumferential portions, wherein the radial portions of a first subset of windings alternate circumferentially with the radial portions of a second subset of windings, and wherein the circumferential portions of the first subset of windings are superposed with the circumferential portions of the second subset of windings, such that, in operation, the first and second subsets of windings are arranged substantially in a single plane.

The coil arrangement may also include a third subset of windings, wherein the radial portions of a first, second and third subsets of windings alternate circumferentially relative to each other, and wherein the circumferential portions of the first, second and third subsets of windings are superposed relative to each other, such that, in operation, the first, second and third subsets of windings are arranged substantially in a single plane. In this manner, the axial space for each winding of the coil arrangement is relatively small. Each winding may be formed of two semi-circular winding portions that are connectable so as to form a full circumferential arrangement. Each one of the semi-circular winding portions may be configured to fit within a respective portion of a clamshell-type outer stator assembly and may have respective wires that extend to a terminal connection. The wires may be arranged at the terminal connection so as to provide a wye connection, and/or the wires may be arranged at the terminal connection so as to provide a delta connection.

Additional features of example embodiments of the present invention are described in more detail below with reference to the appended Figures.

### BRIEF DESCRIPTION OF THE DRAWINGS

FIG. 1 is a partial side, cross-sectional view of a device according to an example embodiment of the present invention.

FIG. 2 is a side, cross-sectional view of a device according to an example embodiment of the present invention.

FIG. 3(a) is a perspective view of a device according to an example embodiment of the present invention.

FIG. 3(b) is an exploded view of the device illustrated in FIG. 3(a).

FIG. 3(c) is a front view of the device illustrated in FIGS. 3(a) and 3(b).

FIG. 3(d) is an exploded view of the device illustrated in FIGS. 3(a) to 3(c).

FIG. 3(e) is an exploded view of various components of an inner stator of the device illustrated in FIGS. 3(a) to 3(d).

FIG. 4(a) is a top view of a lower coil element of a device according to an example embodiment of the present invention.

FIG. 4(b) is a top view of a portion of the lower coil element illustrated in FIG. 4(a).

FIG. 4(c) is a perspective view of a portion of the lower coil element illustrated in FIG. 4(a).

FIG. 4(d) is a top view of a single phase winding of the lower coil element illustrated in FIG. 4(a).

FIG. 4(e) is a perspective view of a single coil of one phase of the lower coil element illustrated in FIG. 4(a).

FIG. 4(f) is a cross-sectional view of a portion of the lower coil element illustrated in FIG. 4(a).

FIG. 4(g) is a cross-sectional view of the lower coil element illustrated in FIG. 4(a).

FIG. 5(a) is a cross-sectional view of a device, according to an example embodiment of the present invention.

FIG. 5(b) is a perspective, cross-sectional view that illustrates additional details of the generator stator assembly and the inner stator components of the generator assembly.

FIGS. 5(c) and 5(d) illustrate side and front views, respectively, of the generator assembly.

FIG. 5(e) is a perspective, cross-sectional view, FIG. 5(f) is a longitudinal, cross-sectional view, and FIG. 5(g) is an end view, which illustrate additional details of the rotor assembly of the generator assembly.

FIGS. 6(a) and (b) illustrate various exemplary arrangements of terminal connections.

### DETAILED DESCRIPTION

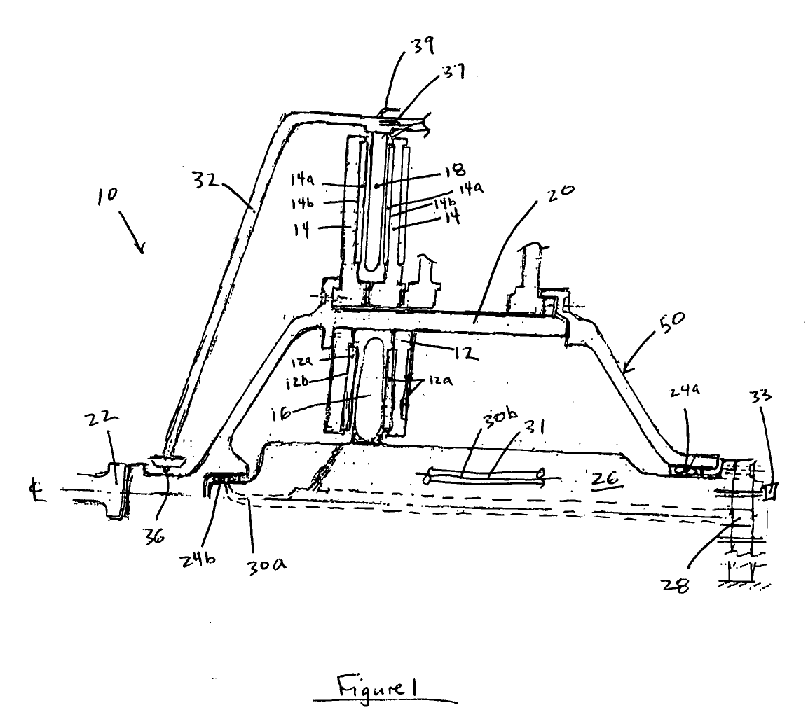

FIG. 1 is a cross-sectional view that illustrates a device 10 according to an example embodiment of the present invention. The device 10 may be arranged as an axial flux permanent magnet generator assembly. Alternatively, the device 10 may be arranged as a motor assembly. In addition, one side of the device, e.g., the radially outer side, may be arranged as a generator device, and the other side of the device 10, e.g., the radially inner side, may be arranged as a motor assembly.

For the purposes of example only, the device 10 is described below as a generator assembly, which is sized and configured to generate a continuous output of, e.g., 100 kW of power and a peak output of, e.g., 120 kW of power. However, it should be understood that the device 10 may be sized and configured to generate any amount of power. The generator assembly 10 includes a generator stator assembly 32, a rotor assembly 50 and an inner stator 26. While the generator stator assembly 32 and the inner stator 26 are configured to remain stationary, the rotor assembly 50 is configured to move, e.g., rotate, relative to the generator stator assembly 32 and the inner stator 26. The rotor assembly 50 may be attached on one of its axial ends to an input shaft of, e.g., a prime mover 22 such as an engine, by a suitably designed coupling arrangement. The rotor assembly 50 may be supported at regions near to its axial ends by bearing assemblies, such as bearing assemblies 24a and 24b located at respective first and second axial ends of the inner stator 26.

As illustrated in FIG. 1, the generator assembly 10 includes inner magnetic disk assemblies 12 and outer magnetic disk assemblies 14, which along with the rotor spool 20 form the rotor assembly 50. Each of the inner and outer magnetic disk assemblies 12, 14 include inner and outer magnetic elements 12a, 14a, respectively, as will be set forth in greater detail below. The magnetic elements may include, e.g., samarium-cobalt magnets or other suitable types of permanent magnets.

The rotor assembly 50 includes a plurality of inner magnetic disk assemblies 12 and a plurality of outer magnetic disk assemblies 14. Each of the inner and outer magnetic disk assemblies 12 are secured in a radial arrangement to the rotor spool 20. Each of the inner magnetic disk assemblies 12 extends radially inwardly from the rotor spool 20, and each of the outer magnetic disk assemblies 14 extends radially outwardly from the rotor spool 20. The inner and outer magnetic disk assemblies 12, 14, along with their respective inner and outer coil assemblies 16, 18, form a densely packaged, high power output assembly.

Each of the inner magnetic disk assemblies 12 is arranged on and secured to an inner circumferential surface of the rotor spool 20. A first inner magnetic disk assembly 12 is located at a first axial end of the rotor spool 20. A second inner magnetic disk assembly 12 is located at a second axial end of the rotor spool 20. Additional inner magnetic disk assemblies 12 are arranged in a similar manner along the inner circumferential surface of the rotor spool 20 at axial locations in between the first and second inner magnetic disk assemblies 12. Each of the plurality of inner magnetic disk assemblies 12 is arranged a predetermined axial space apart from an adjacent inner magnetic disk assembly 12.

As set forth above, each of the inner magnetic disk assemblies 12 includes inner magnetic elements 12a. For example, each of the inner magnetic disk assemblies 12 has a face 12b that, in the exemplary embodiment illustrated, is arranged perpendicular to the longitudinal axis of the inner stator 26. Inner magnetic elements 12a are provided on certain faces 12b. For example, the first and second inner magnetic disk assemblies 12, e.g., the inner magnetic disk assemblies 12 that are located at the first and second ends of the rotor spool 20, have inner magnetic elements 12a secured to their interior faces 12b, e.g., those faces 12b that are immediately adjacent to another inner magnetic disk assembly 12. The exterior faces 12b of the first and second inner magnetic disk assemblies 12, e.g., the faces 12b that face respective axial ends of the rotor spool 12, may have no inner magnetic element 12a secured thereto. The remaining inner magnetic disk assemblies 12, e.g., those that are arranged along the inner circumferential surface of the rotor spool 20 at axial locations in between the first and second inner magnetic disk assemblies 12, may have inner magnetic elements 12a secured to both of their faces 12b, as both of their faces 12b are immediately adjacent to another inner magnetic disk assembly 12. It should be understood that any number of inner magnetic disk assemblies 12 may be provided. Arranged within each axial space between adjacent inner magnetic disk assemblies 12 are inner coil assemblies 16, which are described in greater detail below.

Also, each of the outer magnetic disk assemblies 14 is arranged on and secured to an outer circumferential surface of the rotor spool 20. A first outer magnetic disk assembly 14 is located at a first axial end of the rotor spool 20. A second outer magnetic disk assembly 14 is located at a second axial end of the rotor spool 20. Additional outer magnetic disk assemblies 14 are arranged along the outer circumferential surface of the rotor spool 20 at axial locations in between the first and second outer magnetic disk assemblies 14. Each of the outer magnetic disk assemblies 14 is arranged a predetermined axial space apart from an adjacent outer magnetic disk assembly 14.

As set forth above, each of the outer magnetic disk assemblies 14 includes outer magnetic elements 14a. For example, each of the outer magnetic disk assemblies 14 has a face 14b that, in the exemplary embodiment illustrated, is arranged perpendicular to the longitudinal axis of the inner stator 26. Outer magnetic elements 14a are arranged on certain faces 14b. For example, the first and second outer magnetic disk assemblies 14, e.g., the outer magnetic disk assemblies 14 that are located at the first and second ends of the rotor spool 20, have outer magnetic elements 14a secured to their interior faces 14b, e.g., those faces 14b that are immediately adjacent to another outer magnetic disk assembly 14. The exterior faces 14b of the first and second outer magnetic disk assemblies 14, e.g., the faces 14b that face axial ends of the rotor spool 12, may have no outer magnetic element 14a secured thereto. The remaining outer magnetic disk assemblies 14, e.g., those that are arranged along the outer circumferential surface of the rotor spool 20 at axial locations in between the first and second outer magnetic disk assemblies 14, may have outer magnetic elements 14a secured to both of their faces 12b, as both of their faces 12b are immediately adjacent to another outer magnetic disk assembly 14. It should be understood that any number of outer magnetic disk assemblies 14 may be provided. Arranged within each axial space between adjacent outer magnetic disk assemblies 14 are outer coil assemblies 18, which are described in greater detail below.

As set forth above, arranged within each axial space between adjacent inner magnetic disk assemblies 12 are inner coil assemblies 16. Each inner coil assembly 16 may include wire bundles, e.g., copper wire. The precise geometry of the inner coil assemblies 16 may depend, for example, on electromagnetic considerations, on the requirements of the generator, etc., but generally may be tightly wound to form a rigid structure, generally in an annular-shaped configuration.

Each inner coil assembly 16 is arranged on and secured to an outer circumferential surface of the inner stator 26. A first inner coil assembly 16 is located at a first axial end of the inner stator 26. A second inner coil assembly 16 is located at a second axial end of the inner stator 26. Additional inner coil assemblies 16 are arranged along the outer circumferential surface of the inner stator 26 at axial locations in between the first and second inner coil assemblies 16. Each inner coil assembly 16 is arranged a predetermined axial space apart from an adjacent inner coil assembly 16.

As illustrated in FIG. 1, the location and axial spacing of each inner coil assembly 16, along with the location and axial spacing of each inner magnetic disk assembly 12, is such that an inner coil assembly 16 is arranged within a respective one of the axial spaces between adjacent inner magnetic disk assemblies 12. For example, the first inner coil assembly 16, e.g., located at the first axial end of the inner stator 26, is arranged between the first inner magnetic disk assembly 12, e.g., located at the first axial end of the rotor spool 20, and the inner magnetic disk assembly 12 immediately adjacent to the first inner magnetic disk assembly 12. In this manner, the first inner coil assembly 16 is arranged between two magnetic elements 12a, e.g., one each being secured to the faces 12b of the first inner magnetic disk assembly 12 and the inner magnetic disk assembly 12 immediately adjacent to it. Likewise, the second inner coil assembly 16, e.g., located at the second axial end of the inner stator 26, is arranged between the second inner magnetic disk assembly 12, e.g., located at the second axial end of the rotor spool 20, and the inner magnetic disk assembly 12 immediately adjacent to the second inner magnetic disk assembly 12. In this manner, the second inner coil assembly 16 is arranged between two magnetic elements 12a, e.g., one each secured to the faces 12b of the second inner magnetic disk assembly 12 and the inner magnetic disk assembly 12 immediately adjacent to it. Also, each of the remaining inner coil assemblies 16, e.g., located between the first and second inner coil assemblies, is arranged between other inner magnetic disk assemblies 12, so as to be arranged between the magnetic elements 12a secured to the faces 12b of the other respective inner magnetic disk assemblies 12. It should be understood that any number of inner coil assemblies 16 may be included, depending on the respective number of inner magnetic disk assemblies 12. The inner coil assemblies 16 and the inner magnetic disk assemblies 12 may be configured such that the inner and outer radial diameters of each one of the inner coil assemblies 16 extends beyond the inner and outer diameters, respectively, of the inner magnetic elements 12 between which it is arranged.

Also and as set forth above, arranged within each axial space between adjacent outer magnetic disk assemblies 14 are outer coil assemblies 18. Each outer coil assembly 18 may include wire bundles, e.g., copper wire. The precise geometry of the outer coil assemblies 18 may depend, for example, on electromagnetic considerations, on the requirements of the generator, etc., but generally may be tightly wound to form a rigid structure, generally in an annular-shaped configuration.

Each outer coil assembly 18 is arranged on and secured to an inner circumferential surface of a generator stator assembly 32, which is described in greater detail below. A first outer coil assembly 18 is located at a first axial end of the inner circumferential surface of the generator stator assembly 32. A second outer coil assembly 18 is located at a second axial end of the inner circumferential surface of the generator stator assembly 32. Additional outer coil assemblies 18 are arranged along the inner circumferential surface of the generator stator assembly 32 at axial locations in between the first and second outer coil assemblies 18. Each outer coil assembly 18 is arranged a predetermined axial space apart from an adjacent outer coil assembly 18.

As illustrated in FIG. 1, the location and axial spacing of each outer coil assembly 18, along with the location and axial spacing of each outer magnetic disk assembly 14, is such that an outer coil assembly 18 is arranged within a respective axial space between adjacent outer magnetic disk assemblies 14. For example, the first outer coil assembly 18, e.g., located at the first axial end of the inner circumferential surface of the generator stator assembly 32, is arranged between the first outer magnetic disk assembly 14, e.g., located at the first axial end of the rotor spool 20, and the outer magnetic disk assembly 14 immediately adjacent to the first outer magnetic disk assembly 14. In this manner, the first outer coil assembly 18 is arranged between the magnetic elements 14a secured to the faces 14b of the first outer magnetic disk assembly 14 and the outer magnetic disk assembly 14 immediately adjacent to it. The second outer coil assembly 18, e.g., located at the second axial end of the inner circumferential surface of the generator stator assembly 32, is arranged between the second outer magnetic disk assembly 14, e.g., located at the second axial end of the rotor spool 20, and the outer magnetic disk assembly 14 immediately adjacent to the second outer magnetic disk assembly 14. In this manner, the second outer coil assembly 18 is arranged between the magnetic elements 14a secured to the faces 14b of the second outer magnetic disk assembly 14 and the outer magnetic disk assembly 14 immediately adjacent to it. Also, each of the remaining outer coil assemblies 18, e.g., located between the first and second outer coil assemblies, is arranged between other respective outer magnetic disk assemblies 14, so as to be arranged between the magnetic elements 14a secured to the faces 14b of the other respective outer magnetic disk assemblies 14. It should be understood that any number of outer coil assemblies 18 may be provided, depending on the number of outer magnetic disk assemblies 14. The outer coil assemblies 18 and the outer magnetic disk assemblies 14 may be configured such that the inner and outer radial diameters of each of the outer coil assemblies 18 extends beyond the inner and outer diameters, respectively, of the outer magnetic elements 14 between which it is arranged.

As set forth above, the rotor assembly 50 may be supported at regions near to its axial ends by bearing assemblies. In the exemplary embodiment illustrated in FIG. 1, bearing assembly 24a is located at a first axial end of the inner stator 26, while bearing assembly 24b is located at a second axial end of the inner stator 26. In order to provide adequate lubrication to the bearing assemblies 24a, 24b, the inner stator 26 includes an opening 28 that communicates with passage 30a for conveying lubricating oil, or any type of lubrication medium, to the bearing assemblies 24a, 24b. Also, the inner stator 26 may also employ the passage 30a, or any other suitable passage or conveyance, to provide lubricating and/or cooling oil to the region between the outer circumferential surface of the inner stator 26 and the inner circumferential surface of the rotor spool 20. In addition, the inner stator 26 may include passages 31 for wires 30b extending from the inner coil assemblies 16. Wires 30b of the inner coil assemblies 16 may be suitably arranged, e.g., grouped, and may pass through the passages 31 of the inner stator so as to form terminal connections 33, e.g., at a terminal plate located outside of the inner stator 26 or at any other suitable location. The electrical output of the generator assembly 10 (or electrical input if the device 10 is arranged as a motor) is provided at these terminal connections 33. The specific arrangement in which the wires 30b are gathered, and the specific arrangement or type of terminal connections into which the wires 30b are formed, may depend on the desired electrical characteristics of the generator assembly 10, among other factors. FIGS. 6(a) and (b), which are described in further detail below, illustrate various example arrangements of the terminal connections 33.

In addition, the generator stator assembly 32, which forms an outer shell of the generator assembly 10, may be supported relative to the rotor assembly 50, at regions near to its axial ends by bearing and/or sealing assemblies. In the exemplary embodiment illustrated in FIG. 1, sealing assembly 36 is located at a second axial end of the rotor spool 20. A sealing assembly may be located at the first axial end of the rotor spool 20. In order to provide adequate lubrication to any bearing assemblies between the rotor spool 20 and the generator stator assembly 32, the generator stator assembly 32 may include one or more passages for conveying lubricating oil, or any type of lubrication medium, to the bearing assemblies. Also, the generator stator assembly 32 may also employ such a passage or passages, or any other suitable conveyance, to provide lubricating and/or cooling oil to the region between the outer circumferential surface of the rotor spool 26 and the inner circumferential surface of the generator stator assembly 32. In addition, the generator stator assembly 32 may include passages 37 for wires 38 extending from the outer coil assemblies 18. The wires 38 of the outer coil assemblies 18 may be suitably arranged, e.g., grouped, and may pass through the passages 37 of the generator stator assembly 32 so as to form terminal connections 39, e.g., at a terminal plate located outside of the generator stator assembly 32 or at any other suitable location. The electrical output of the generator assembly 10 (or the electrical input if the device 10 is arranged as a motor) is provided at these terminal connections 39. The specific arrangement in which the wires 37 are gathered, and the specific arrangement or type of terminal connections into which the wires 37 are formed, may depend on the desired electrical characteristics of the generator assembly 10, among other factors. In addition, the generator stator assembly 32 may include a mounting element suitable to secure the generator assembly 10 to a base plate or any other type of foundation.

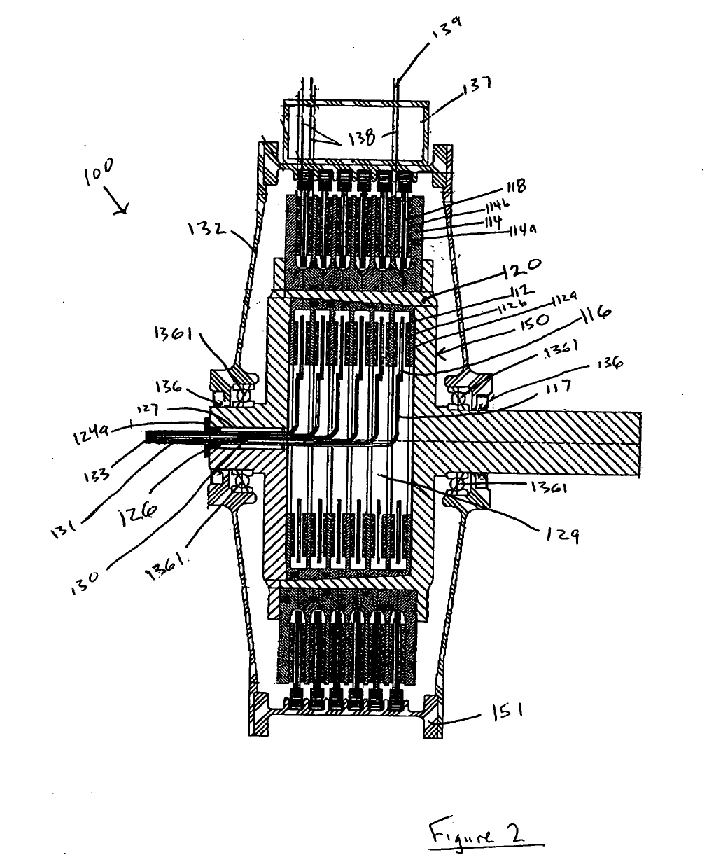

FIG. 2 is a cross-sectional view that illustrates a device 100 according to an example embodiment of the present invention. Device 100 may be arranged as a generator or a motor, or both. For the purposes of example only, the device 100 is described herein as a generator assembly sized and configured to generate 100 kW of power. However, it should be understood that the generator assembly 100 may be sized and configured to generate any amount of power. The generator assembly 100 includes a generator stator assembly 132, a rotor assembly 150 and an inner stator 126. While the generator stator assembly 132 and the inner stator 126 are configured to remain stationary, the rotor assembly 150 is configured to rotate relative to the generator stator assembly 132 and the inner stator 126. The rotor assembly 150 is attachable at a first axial end to, e.g., an engine 122, by a suitably designed coupling arrangement. The rotor assembly 150 is supported at regions near to its axial ends by bearing assemblies 124a and 124b located at respective first and second axial ends of the inner stator 126.

The generator assembly 100 includes magnetic disk assemblies 112, 114, which along with the rotor spool 120 form the rotor assembly 150. Each inner and outer magnetic disk assembly 112, 114 includes inner and outer magnetic elements 112a, 114a, respectively. The rotor assembly 150 includes a plurality of inner magnetic disk assemblies 112 and a plurality of outer magnetic disk assemblies 114. Each inner and outer magnetic disk assembly 112, 114 is secured in a radial arrangement to the rotor spool 120. Each inner magnetic disk assembly 112 extends radially within the rotor spool 120, while each outer magnetic disk assembly 114 extends radially outside of the rotor spool 120.

Each inner magnetic disk assembly 112 is arranged on and secured to an inner circumferential surface of the rotor spool 120, and each inner magnetic disk assembly 112 is arranged a predetermined axial space apart from an adjacent inner magnetic disk assembly 112. Each inner magnetic disk assembly 112 includes inner magnetic elements 112a on a respective face 112b. The inner magnetic disk assemblies 112 that are located at first and second ends of the rotor spool 120 have inner magnetic elements 112a secured to their interior faces 112b, while their exterior faces 112b have no inner magnetic element 112a secured thereto. The remaining inner magnetic disk assemblies 112 that are arranged along the inner circumferential surface of the rotor spool 120 at axial locations in between the first and second inner magnetic disk assemblies 112 have inner magnetic elements 112a secured to both of their faces 112b. Arranged within each one of the axial spaces between adjacent inner magnetic disk assemblies 112 are inner coil assemblies 116.

Also, each outer magnetic disk assembly 114 is arranged on and secured to an outer circumferential surface of the rotor spool 120. Each outer magnetic disk assembly 114 is arranged a predetermined axial space apart from an adjacent outer magnetic disk assembly 114. Each outer magnetic disk assembly 114 includes outer magnetic elements 114a on a respective face 114b. The outer magnetic disk assemblies 114 that are located at respective first and second ends of the rotor spool 120 have outer magnetic elements 114a secured to their interior faces 114b, while their exterior faces 114b have no outer magnetic element 114a secured thereto. The remaining outer magnetic disk assemblies 114 arranged along the outer circumferential surface of the rotor spool 120 at axial locations in between the first and second outer magnetic disk assemblies 114 have outer magnetic elements 114a secured to both of their faces 114b. Arranged within each axial space between adjacent outer magnetic disk assemblies 114 are outer coil assemblies 118.

As set forth above, arranged within each axial space between adjacent inner magnetic disk assemblies 112 are inner coil assemblies 116, including copper wire bundles that are tightly wound to form a rigid structure. Each inner coil assembly 116 is arranged on and secured to the inner stator 126. The inner stator 126 extends through a longitudinally disposed bore 127 at one end of the rotor assembly 150. The inner coil assemblies 116 are supported by inner coil support elements 117. The inner coil support elements 117 are each arranged so as to initially extend longitudinally from one end of the inner stator 126 within an opening 129 of the rotor assembly 150, and then to turn so as to be radially disposed within the opening 129. In this manner, the inner coil assemblies 116, that are secured to outer radial ends of the inner coil support elements 117, are arranged within respective axial spaces between adjacent inner magnetic disk assemblies 112 and the magnetic elements 112a secured thereto. The inner and outer radial diameters of each one of the inner coil assemblies 116 extends beyond the inner and outer diameters, respectively, of the inner magnetic elements 112 between which it is arranged.

Also, arranged within each axial space between adjacent outer magnetic disk assemblies 114 are outer coil assemblies 118, including copper wire bundles that are tightly wound to form a rigid structure. Each outer coil assembly 118 is arranged on and secured to an inner circumferential surface of a generator stator assembly 132, such that the outer coil assemblies 118 are arranged within respective axial spaces between adjacent outer magnetic disk assemblies 114 and the magnetic elements 114a secured thereto. The inner and outer radial diameters of each one of the outer coil assemblies 118 extends beyond the inner and outer diameters, respectively, of the outer magnetic elements 114 between which it is arranged.

The rotor assembly 150 is supported relative to the inner stator 126 by bearing assembly 124a, which is disposed within the bore 127 of the inner stator 126. The inner stator 126 includes a passage 130 for conveying lubricating oil, or any type of lubrication medium, to the bearing assembly 124a. Also, the inner stator 126 employs the passage 130, or any other suitable passage or conveyance, to provide lubricating and/or cooling oil to the opening 129. In addition, the inner stator 126 includes an interior passage 131 for wires 130 extending from the inner coil assemblies 116. The wires 130 of the inner coil assemblies 116 may be arranged together with respective inner coil support elements 117, and pass through the interior passage 131 of the inner stator 126 to terminal connections 133 for providing electrical output of the generator assembly 100.

In addition, the generator stator assembly 132 is supported relative to the rotor assembly 150, at regions near to its axial ends by bearing assemblies 1361 and sealing assemblies 136. In order to provide adequate lubrication to any bearing assemblies between the rotor spool 120 and the generator stator assembly 132, the generator stator assembly 132 may include one or more passages for conveying lubricating oil, or any type of lubrication medium, to the bearing assemblies. Also, the generator stator assembly 132 may also employ such a passage or passages, or any other suitable conveyance, to provide lubricating and/or cooling oil to the region between the outer surfaces of the rotor spool 126 and the inner surfaces of the generator stator assembly 132. In addition, the generator stator assembly 132 may include a terminal housing 137 which includes wires 138 extending from the outer coil assemblies 118. The wires 138 of the outer coil assemblies 118 are grouped and pass into the terminal housing 137 having terminal connections 139 for providing electrical output of the generator assembly 100 (or electrical input to the device 100 if arranged as a motor). In addition, the generator stator assembly 132 may include a mounting element 151 suitable to secure the generator assembly 100 to a base plate or any other type of foundation.

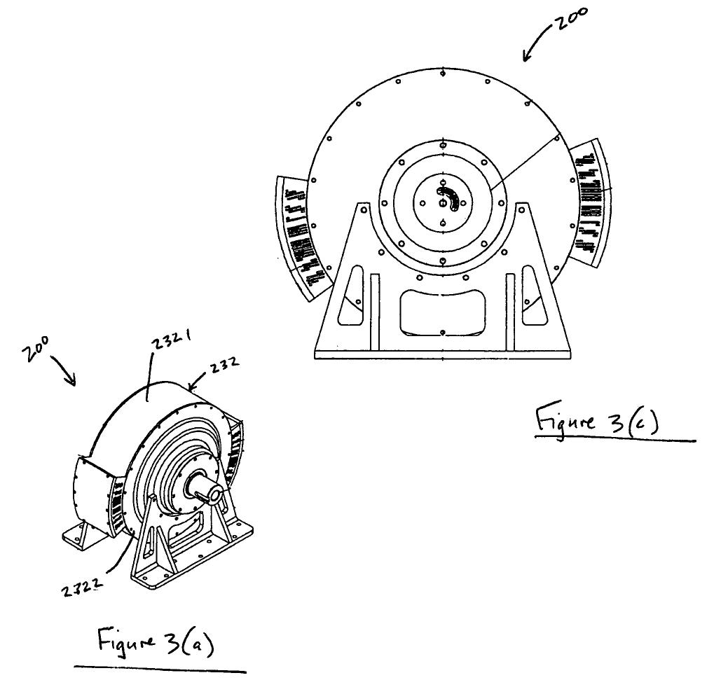

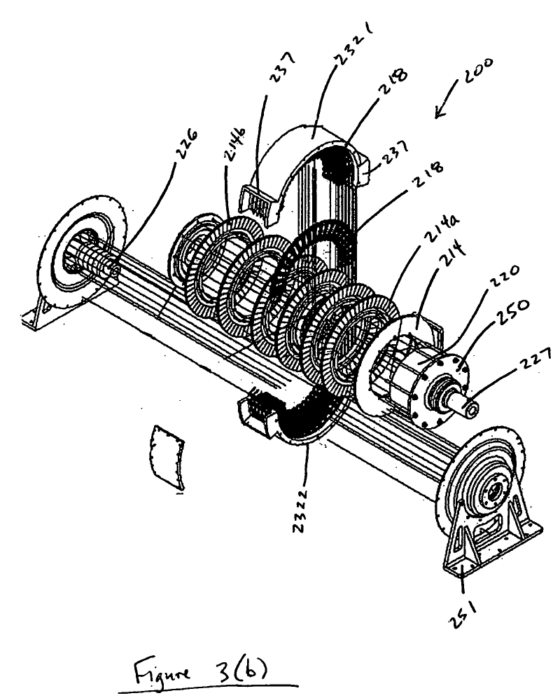

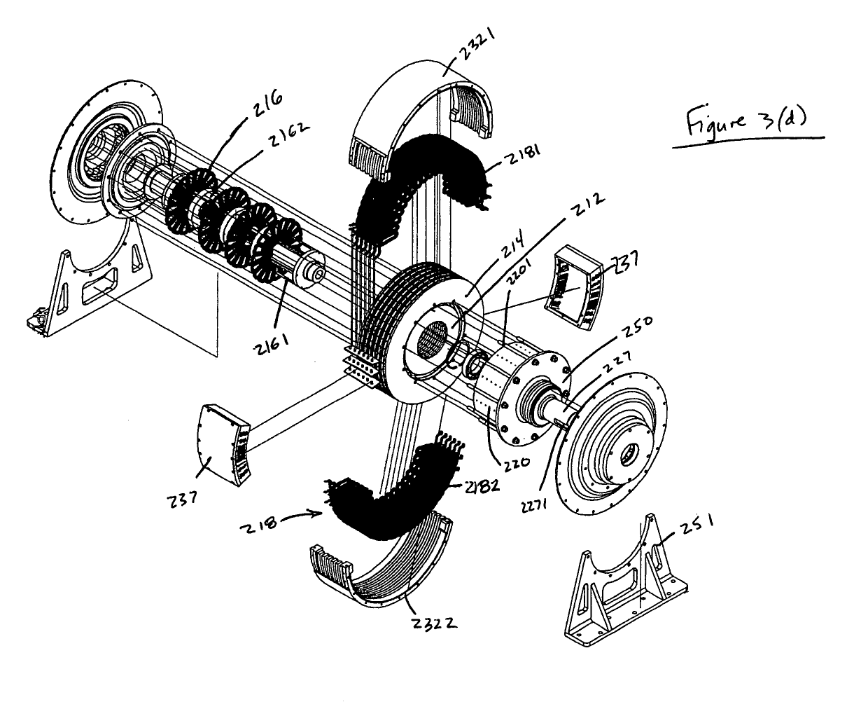

FIG. 3(a) is a perspective view that illustrates a device 200, according to an example embodiment of the present invention. Device 200 may be arranged as a generator, or a motor, or both. FIG. 3(b) is an exploded view of the device 200, and FIG. 3(c) is a front view of the device 200. For the purposes of example only, the device 200 is described below as a generator assembly 200, sized and configured to generate 100 kW of power with its outer magnet/coil arrangement and to generate 15 kW of power with its inner magnet/coil arrangement. However, it should be understood that the inner and outer magnet/coil assemblies of the generator assembly 200 may be sized and configured to generate any amount of power, e.g., depending upon the number of magnet/coil plates in the stack.

Referring to FIG. 3(b), the generator assembly 200 includes a generator stator assembly 232. The generator stator assembly 232 includes an upper housing 2321 and a lower housing 2322. The upper housing 2321 and a lower housing 2322 fit together in clam-shell fashion in order to form the generator stator assembly 232. In addition, the generator assembly 200 includes a rotor assembly 250 and an inner stator 226. While the generator stator assembly 232 and the inner stator 226 are configured to remain stationary, the rotor assembly 250 is configured to rotate relative to the generator stator assembly 232 and the inner stator 226. The rotor assembly 250 is attachable via an input shaft 227 at a first axial end to, e.g., an engine, by a suitably designed coupling arrangement.

As illustrated in FIG. 3(b), the generator assembly 200 includes inner and outer magnetic disk assemblies, which along with a rotor spool 220 form the rotor assembly 250. The inner magnetic disk assemblies are hidden from view in FIG. 3(b). As illustrated, the generator assembly 200 may include, e.g., seven outer magnetic disk assemblies 214. Each outer magnetic disk assembly 214 includes outer magnetic elements 214a. Each outer magnetic disk assembly 214 is secured in a radial arrangement to the rotor spool 220. Each outer magnetic disk assembly 214 extends radially outwardly from the rotor spool 220.

In addition to a plurality of inner magnetic disk assemblies 212 that are arranged on and secured to an inner circumferential surface of the rotor spool 220, each outer magnetic disk assembly 214 is arranged on and secured to an outer circumferential surface of the rotor spool 220. The outer magnetic disk assemblies 214 that are located at respective first and second ends of the rotor spool 220 have outer magnetic elements 214a secured to their interior faces 214b, while their exterior faces 214b have no outer magnetic element 214a secured thereto. The remaining outer magnetic disk assemblies 214 arranged along the outer circumferential surface of the rotor spool 220 at axial locations in between the first and second outer magnetic disk assemblies 214 have outer magnetic elements 214a secured to both of their faces 214b. When assembled, outer coil assemblies 218 are arranged within each axial space between adjacent outer magnetic disk assemblies 214.

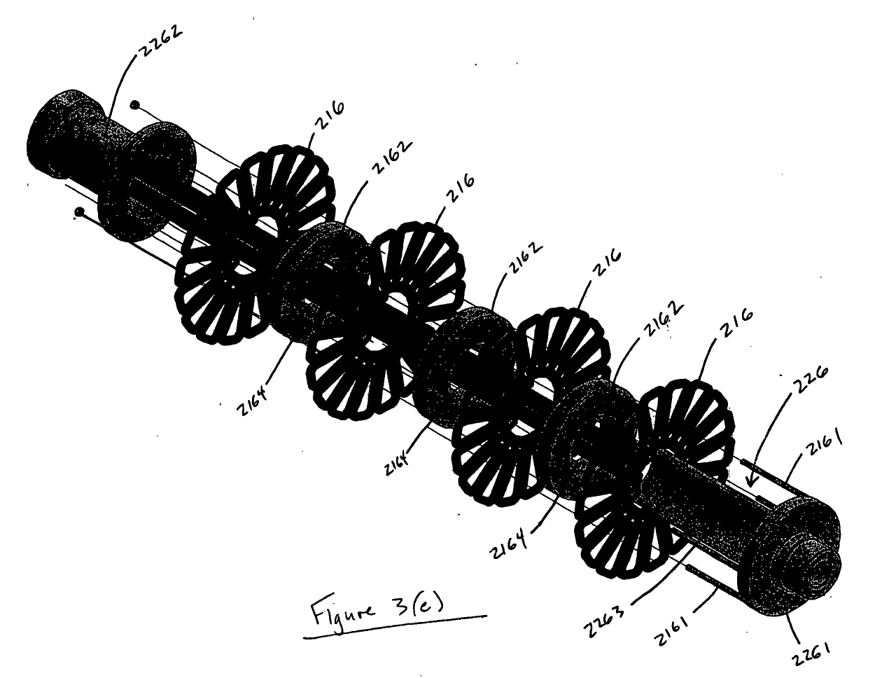

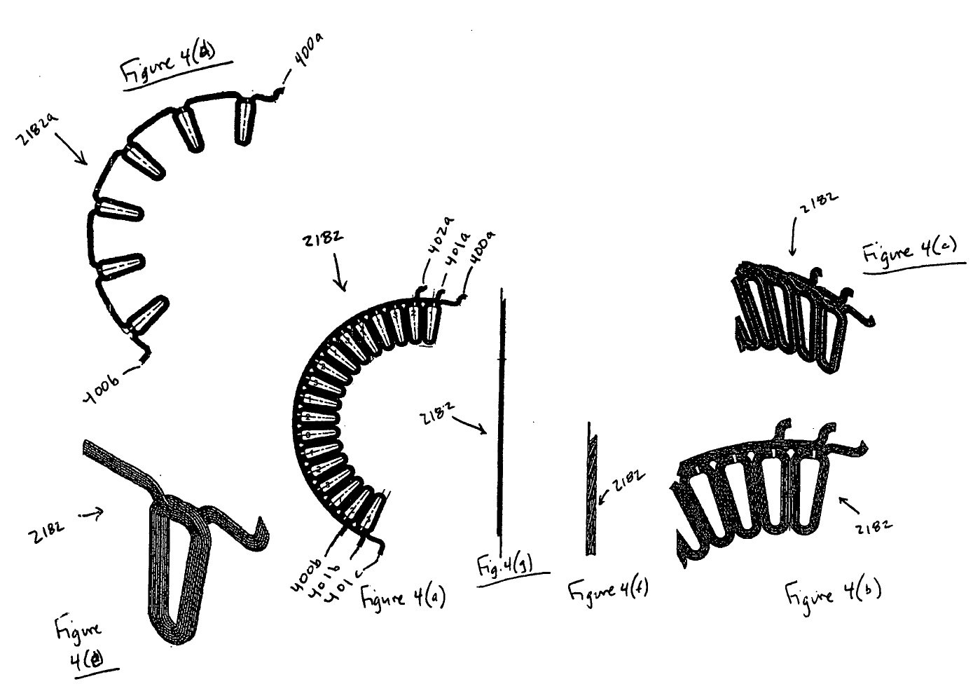

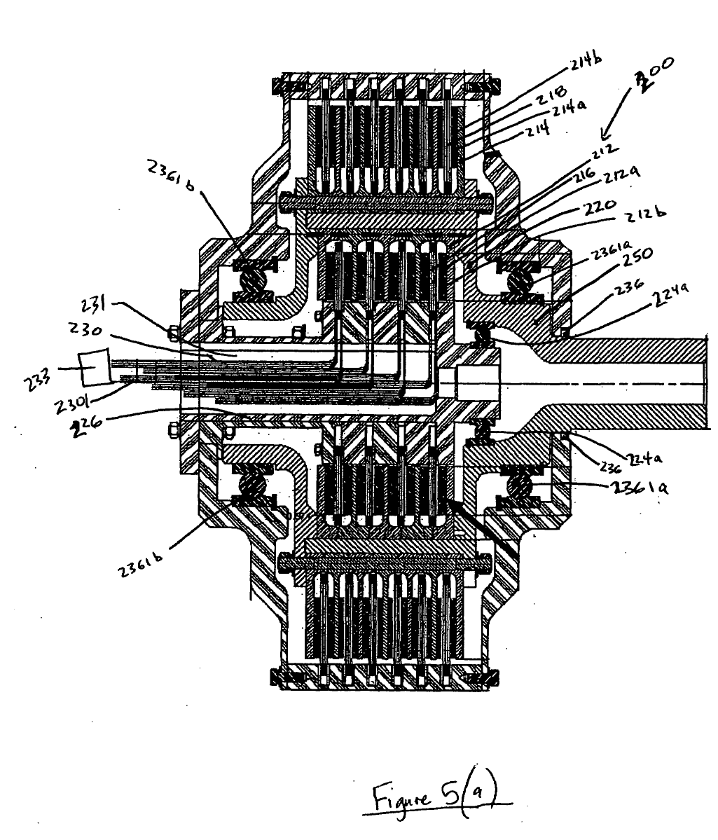

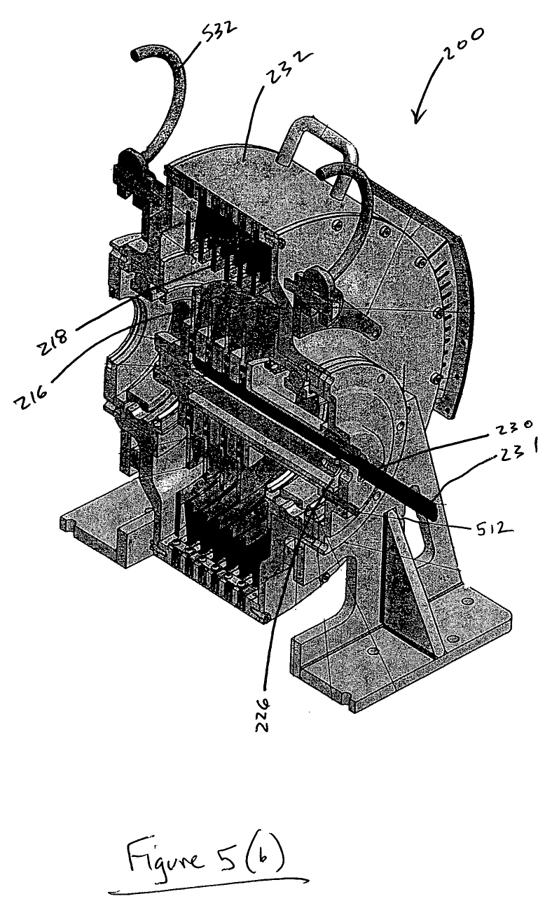

In the exemplary embodiment illustrated, each outer coil assembly 218 is split into an upper coil element 2181 and a lower coil element 2182. The upper coil element 2181 is configured to fit within the upper housing 2321 of the generator stator assembly 232, while the lower coil element 2182 is configured to fit within the lower housing 2322 of the generator stator assembly 232. In this manner, the assembly of the upper housing 2321 and the lower housing 2322 together in clam-shell fashion results in the joining of the upper coil element 2181 with the lower coil element 2182 to form a full circumferential ring of coils. It should be appreciated that the upper section and lower section may be arranged as a generator or a motor, in any combination as desired. Additional details of the outer coil assemblies 218 are described below in connection with FIGS. 4(a) to 4(h). Generally, the outer coil assemblies 218 include copper wire bundles that are tightly wound to form a rigid structure. Each outer coil assembly 218 is arranged on and secured to an inner circumferential surface of the generator stator assembly 232, such that, when assembled, the outer coil assemblies 218 are arranged within respective axial spaces between adjacent outer magnetic disk assemblies 214 and the magnetic elements 214a secured thereto.

FIG. 3(d) is an exploded view of the generator assembly 200. In FIG. 3(d), to better illustrate the inner magnetic disk assemblies 212 and inner coil assemblies 214. As also described above, the generator assembly 200 includes a generator stator assembly 232, which is formed from an upper housing 2321 and a lower housing 2322 that fit together in clam-shell fashion. In addition, the generator assembly 200 includes a rotor assembly 250 and an inner stator 226. The generator stator assembly 232 and the inner stator 226 are configured to remain stationary, while the rotor assembly 250 is configured to rotate relative to the generator stator assembly 232 and the inner stator 226. The rotor assembly 250 is attachable via an input shaft 227 at a first axial end to, e.g., an engine, by a suitably designed coupling arrangement. For example, the input shaft 227 may include, e.g., a keyed slot 2271, for this purpose.

In the example embodiment illustrated in FIG. 3(d), the generator assembly 200 includes inner and outer magnetic disk assemblies, which along with a rotor spool 220 form the rotor assembly 250. The generator assembly 200 may include, e.g., seven outer magnetic disk assemblies 214, which are illustrated in this view as being in close but spaced axial proximity relative to each other. Each outer magnetic disk assembly 214 includes outer magnetic elements 214a. Each outer magnetic disk assembly 214 is secured by fasteners 2201 so as to extend radially outwardly from an outer circumferential surface of the rotor spool 220.

The outer magnetic disk assemblies 214 that are located at respective first and second ends of the rotor spool 220 have outer magnetic elements 214a secured to their interior faces 214b, while their exterior faces 214b have no outer magnetic element 214a secured thereto. The remaining outer magnetic disk assemblies 214 arranged along the outer circumferential surface of the rotor spool 220 at axial locations in between the first and second outer magnetic disk assemblies 214 have outer magnetic elements 214a secured to both of their faces 214b. When assembled, outer coil assemblies 218 are arranged within each axial space between adjacent outer magnetic disk assemblies 214.

In the exemplary embodiment illustrated, each outer coil assembly 218 is split into an upper coil element 2181 and a lower coil element 2182. The upper coil element 2181 is configured to fit within the upper housing 2321 of the generator stator assembly 232 while the lower coil element 2182 is configured to fit within the lower housing 2322 of the generator stator assembly 232. In this manner, the assembly of the upper housing 2321 and the lower housing 2322 together in clam-shell fashion results in the joining of the upper coil element 2181 with the lower coil element 2182 to form a full circumferential ring of coils. Additional details of the outer coil assemblies 218 are described below in connection with FIGS. 4(a) to 4(h). Generally, each outer coil assembly 218 is arranged on and secured to an inner circumferential surface of the generator stator assembly 232, such that, when assembled, the outer coil assemblies 218 are arranged within respective axial spaces between adjacent outer magnetic disk assemblies 214 and the magnetic elements 214a secured thereto.

FIG. 3(d) is an exploded view of the generator assembly 200 that illustrates the inner magnetic disk assemblies 212 arranged within the outer magnetic disk assemblies 214. The inner magnetic disk assemblies 212 are illustrated in this view as being in close but spaced axial proximity relative to each other. The generator assembly 200 may include, e.g., four inner magnetic disk assemblies 212, each inner magnetic disk assembly 212 including inner magnetic elements 212a. Each inner magnetic disk assembly 212 may be secured by fasteners so as to extend radially inwardly from an inner circumferential surface of the rotor spool 220.

The inner magnetic disk assemblies 212 that are located at respective first and second ends of the rotor spool 220 have inner magnetic elements 212a secured to their interior faces 212b, while their exterior faces 212b have no inner magnetic element 212a secured thereto. The remaining inner magnetic disk assemblies 212 arranged along the inner circumferential surface of the rotor spool 220 at axial locations in between the first and second inner magnetic disk assemblies 212 have inner magnetic elements 212a secured to both of their faces 212b. When assembled, inner coil assemblies 216 are arranged within each axial space between adjacent inner magnetic disk assemblies 212.

Configured to be arranged between the inner magnetic disk assemblies 212 are inner coil assemblies 216. In this exemplary embodiment, each inner coil assembly 216 is formed having a plurality of unbroken coils about its entire circumference. Alternatively, each inner coil assembly 216 may be formed of two or more coil elements, e.g., an upper coil element and lower coil element, that may be connected to each other at the time of assembly to form a ring of coils in much the same manner as the upper and lower coil elements 2181, 2182 of the outer coil assemblies 218 are configured to do. Each inner coil assembly 216 is configured to be arranged on and secured to an outer circumferential surface of the inner stator 226 by, e.g., fasteners 2161. When assembled, the inner coil assemblies 216 are arranged within respective axial spaces between adjacent inner magnetic disk assemblies 212 and the inner magnetic elements 212a secured thereto. In order to maintain the axial spacing between the inner coil assemblies 216, inner coil spacer elements 2162 may be arranged between adjacent inner coil assemblies 216. Additional details of the inner coil assemblies 216 are illustrated in FIG. 3(e).

FIG. 3(e) is an exploded view of various components of the inner stator 226 of the generator assembly 200. FIG. 3(e) illustrates the inner coil assemblies 216 that each are formed of an unbroken ring of coils. The inner coil spacer elements 2162 are arranged between adjacent inner coil assemblies 216 so as to maintain the axial spacing between the inner coil assemblies 216. The inner coil assemblies are mounted on the inner stator 226, which includes a first end 2261 that is connectable to a second end 2262 by a tube 2263. For example, in the exemplary embodiment illustrated, the tube 2263 of the inner stator 226 fits within a centrally disposed bore of the inner coil assemblies 216 and of the inner coil spacer elements 2162 such that each inner coil assembly 216 is arranged on an outer circumferential surface of the inner stator 226. As illustrated, the tube 2263 may have a portion of its circumference that is open or slotted, so as to receive wires from the inner coil assemblies 216 into the tube and to pass them through the second end 2262 for eventual connection to a suitable terminal connection. Each inner coil spacer element 2162 may have within its centrally disposed bore an interior shoulder 2164 that mates with the tube 2263 so as to maintain the open or slotted portion of the tube 2263 at a predetermined circumferential position. Extending from the first end 2261 of the inner stator 226 are fasteners 2161 that fit within longitudinal-extending bores of the inner coil assemblies 216, the inner coil spacer elements 2162 and the second end 2262 of the inner stator 226 so as to maintain and secure all of these components relative to each other.

FIGS. 4(a) to 4(g) are various views of the coil assemblies. FIG. 4(a) is a side view of the lower coil element 2182 that is configured to fit within the lower housing 2322 of the generator stator assembly 232. FIG. 4(a) illustrates the lower coil element 2182 having a three-phase winding, e.g., coils for each of three phases. The lower coil element 2182 has a first phase coil entry 400a, which extends to form six coils before culminating in first phase coil exit 400b. The lower coil element 2182 has a second phase coil entry 401a, which extends to form six coils before culminating in a second phase coil exit 401b, and a third phase coil entry 402a, which extends to form six coils before culminating in third phase coil exit 402b. While the lower coil element 2182 is described and illustrated as having six windings per phase, any number of windings may be provided. Also, an upper coil element that is connected to the lower coil element 2182 may have any number, e.g., seven, of windings. The respective coils of each of the three phases are aligned so as to alternate around the circumference of the lower coil element 2182. FIG. 4(b) is a side view of a portion of the lower coil element 2182, while FIG. 4(c) is a perspective view of a portion of the lower coil element 2182. FIGS. 4(b) and 4(c) illustrate the arrangement of the three phase windings in more detail.

FIG. 4(d) is a side view that illustrates a single phase winding 2182a, e.g., the first phase, of the lower coil element 2182. FIG. 4(d) shows the single phase winding 2182a separated from the other two phase winding for the purposes of illustrating its arrangement. Each of the other two phase windings may be similarly sized and shaped as that illustrated in FIG. 4(d). FIG. 4(e) is a perspective view that illustrates a single coil of one phase of the lower coil element 2182. Each of the single coils may be configured such that, when the coils of the three phases are combined so as to form the lower coil element 2182, the lower coil element 2182 has a substantially flat cross-section. FIG. 4(f) is a cross-sectional view of a portion of the lower coil element 2182 illustrating the three phase windings arranged so as to have a substantially flat cross-section. An additional cross-sectional view, illustrating the entire lower coil element 2182, is provided in FIG. 4(g). It should be understood that, while lower coil assembly 2182 is illustrated and described in connection with these figures, the other coils and portions of coils may each have similar arrangements. It should be appreciated that the particular geometry of the windings may provide a pure sine wave output, without the need for additional circuitry, e.g., inverters.

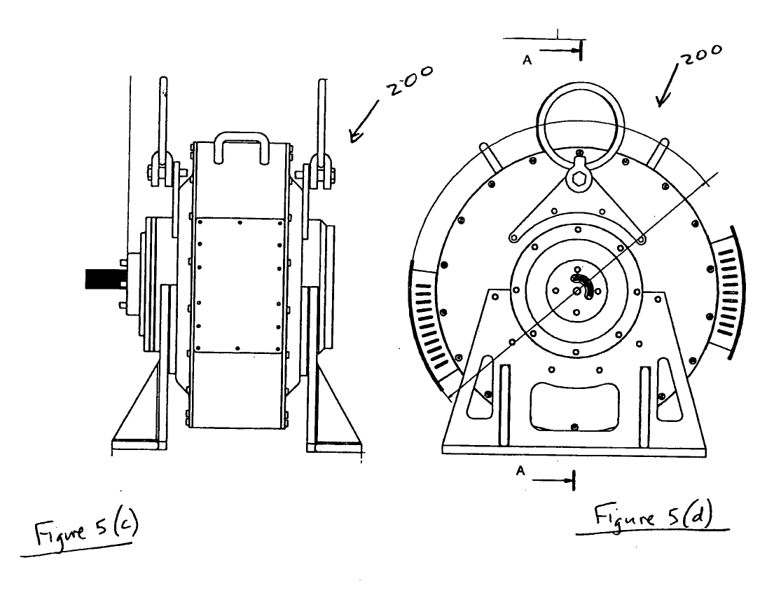

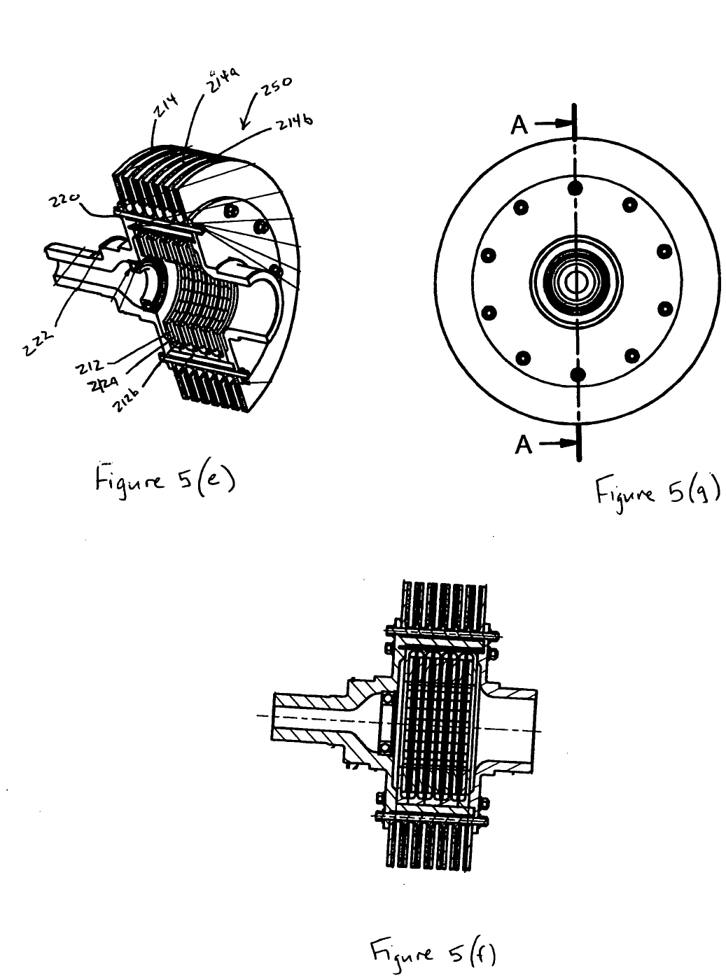

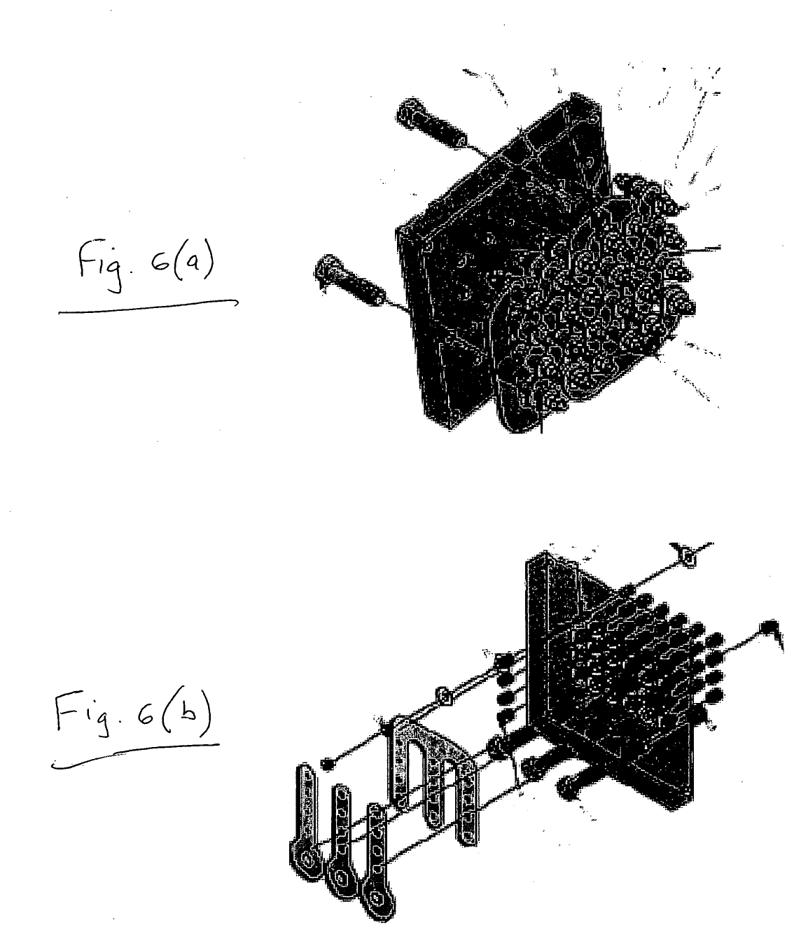

FIG. 5(a) is a side, cross-sectional view that illustrates additional details of the generator assembly 200. As set forth above, the generator assembly 200 includes a generator stator assembly 232, a rotor assembly 250 and an inner stator 226, the generator stator assembly 232 and the inner stator 226 being configured to remain stationary, and the rotor assembly 250 being configured to rotate relative to the generator stator assembly 232 and the inner stator 226. The rotor assembly 250 is attachable at a first axial end via an input shaft 227 to, e.g., an engine, by a suitably designed coupling arrangement. The rotor assembly 250 is supported at regions near to its axial end by bearing assembly 224a located at a first axial end of the inner stator 226.

As should be appreciated from the foregoing, a coil arrangement for a generator and/or a motor includes a plurality of windings arranged substantially in a single plane. Each winding includes: a first circumferential portion following a substantially arcuate path; a first radial portion extending radially inwardly from a first end of the first circumferential portion; an intermediate portion, a first end of the intermediate portion arranged at a radially inward end of the first radial portion; a second radial portion extending radially outwardly from a second end of the intermediate portion; and a second circumferential portion following a substantially arcuate path, a first end of the second circumferential portion arranged at a radially outward end of the second radial portion. The first circumferential portion of each winding is connected to the second circumferential portion of a circumferentially adjacent winding. The windings may include subsets corresponding to individual phases. For example, the windings may include at least a first subset of windings corresponding to a first phase and a second subset of windings corresponding to a second phase; or the windings may include a first subset of windings corresponding to a first phase, a second subset of windings corresponding to a second phase and a third subset of winding corresponding to a third phase. Each winding may include a plurality of conductors. The windings may be arranged circumferentially about a substrate, which may be, e.g., circular, semi-circular, etc.

As illustrated in FIG. 5(a), the generator assembly 200 includes magnetic disk assemblies 212, 214, which along with the rotor spool 220 form the rotor assembly 250. Each of the inner and outer magnetic disk assemblies 212, 214 includes inner and outer magnetic elements 212a, 214a, respectively. The rotor assembly 250 includes a plurality of inner magnetic disk assemblies 212 and a plurality of outer magnetic disk assemblies 214. Each of the inner and outer magnetic disk assemblies 212, 214 is secured in a radial arrangement to the rotor spool 220. Each inner magnetic disk assembly 212 extends radially within the rotor spool 220, while each outer magnetic disk assembly 214 extends radially outside of the rotor spool 220.

Each inner magnetic disk assembly 212 is arranged on and secured to an inner circumferential surface of the rotor spool 220, and each inner magnetic disk assembly 212 is arranged a predetermined axial space apart from an adjacent inner magnetic disk assembly 212. Each inner magnetic disk assembly 212 includes inner magnetic elements 212a on a respective face 212b. The inner magnetic disk assemblies 212 that are located at respective first and second ends of the rotor spool 220 have inner magnetic elements 212a secured to their interior faces 212b, while their exterior faces 212b have no inner magnetic element 212a secured thereto. The remaining inner magnetic disk assemblies 212 that are arranged along the inner circumferential surface of the rotor spool 220 at axial locations in between the first and second inner magnetic disk assemblies 212 have inner magnetic elements 212a secured to both of their faces 212b. Arranged within each axial space between adjacent inner magnetic disk assemblies 212 are inner coil assemblies 216.

Also, each outer magnetic disk assembly 214 is arranged on and secured to an outer circumferential surface of the rotor spool 220, and each outer magnetic disk assembly 214 is arranged a predetermined axial space apart from an adjacent outer magnetic disk assembly 214. Each outer magnetic disk assembly 214 includes outer magnetic elements 214a on a respective face 214b. The outer magnetic disk assemblies 214 that are located at respective first and second ends of the rotor spool 220 have outer magnetic elements 214a secured to their interior faces 214b, while their exterior faces 214b have no outer magnetic element 214a secured thereto. The remaining outer magnetic disk assemblies 214 arranged along the outer circumferential surface of the rotor spool 220 at axial locations in between the first and second outer magnetic disk assemblies 214 have outer magnetic elements 214a secured to both of their faces 214b. Arranged within each axial space between adjacent outer magnetic disk assemblies 214 are outer coil assemblies 218.

Each inner coil assembly 216 is arranged on and secured to an outer circumferential surface of the inner stator 226. A first inner coil assembly 216 is located at a first axial end of the inner stator 226, and a second inner coil assembly 216 is located at a second axial end of the inner stator 226. Additional inner coil assemblies 216 are arranged in a similar manner along the outer circumferential surface of the inner stator 226 at axial locations in between the first and second inner coil assemblies 216. Each inner coil assembly 216 is arranged a predetermined axial space apart from an adjacent inner coil assembly 216.

As illustrated in FIG. 5(a), the location and axial spacing of each inner coil assembly 216, along with the location and axial spacing of each inner magnetic disk assembly 212, is such that an inner coil assembly 216 is arranged within a respective one of the axial spaces between adjacent inner magnetic disk assemblies 212. The first inner coil assembly 216, e.g., located at the first axial end of the inner stator 226, is arranged between the first inner magnetic disk assembly 212, e.g., located at the first axial end of the rotor spool 220, and the inner magnetic disk assembly 212 immediately adjacent to the first inner magnetic disk assembly 212. In this manner, the first inner coil assembly 216 arranged between the magnetic elements 212a secured to the faces 212b of the first inner magnetic disk assembly 212 and the inner magnetic disk assembly 212 immediately adjacent to it. The second inner coil assembly 216, e.g., located at the second axial end of the inner stator 226, is arranged between the second inner magnetic disk assembly 212, e.g., located at the second axial end of the rotor spool 220, and the inner magnetic disk assembly 212 immediately adjacent to the second inner magnetic disk assembly 212. In this manner, the second inner coil assembly 216 is arranged between the magnetic elements 212a secured to the faces 212b of the second inner magnetic disk assembly 212 and the inner magnetic disk assembly 212 immediately adjacent to it. Also, each one of the remaining inner coil assemblies 216, e.g., located between the first and second inner coil assemblies, is arranged between other respective inner magnetic disk assemblies 212, so as to be arranged between the magnetic elements 212a secured to the faces 212b of the other respective inner magnetic disk assemblies 212.

Also, arranged within each axial space between adjacent outer magnetic disk assemblies 214 are outer coil assemblies 218, including copper wire bundles that are tightly wound to form a rigid structure. Each outer coil assembly 218 is arranged on and secured to an inner circumferential surface of a generator stator assembly 232, such that the outer coil assemblies 218 are arranged within respective axial spaces between adjacent outer magnetic disk assemblies 214 and the magnetic elements 214a secured thereto, similar to the arrangement described above for the inner magnetic disk and coil assemblies 212, 216. The inner and outer radial diameters of each inner and outer coil assemblies 216, 218 extends beyond the inner and outer diameters, respectively, of the inner and outer magnetic elements 212, 214 between which it is arranged.

The rotor assembly 250 is supported relative to the inner stator 226 by bearing assembly 224a. The inner stator 226 includes a passage 230 for conveying lubricating oil, or any type of lubrication medium, to the bearing assembly 224a. In addition, the inner stator 226 includes an interior passage 231 for wires 2301 extending from the inner coil assemblies 216. The wires 230 of the inner coil assemblies 216 may be suitable arranged, e.g., grouped, and may pass through the passages 231 of the inner stator so as to form terminal connections 233, e.g., at a terminal plate located outside of the inner stator 226. The electrical output of the inner magnetic disk and coil assemblies 212, 216 (or the electrical input if the device is arranged as a motor rather than a generator) is provided at these terminal connections 233. The specific arrangement in which the wires 230 are gathered, and the specific arrangement or type of terminal connections into which the wires 230 are formed, may depend on the desired electrical characteristics of the generator assembly 200, among other factors.

In addition, the generator stator assembly 232 is supported relative to the rotor assembly 250, at regions near to its axial ends by bearing assemblies 2361a and 2361b, and sealing assemblies 236. In order to provide adequate lubrication to any bearing assemblies between the rotor spool 220 and the generator stator assembly 232, the generator stator assembly 232 may include one or more passages for conveying lubricating oil, or any type of lubrication medium, to the bearing assemblies. Also, the generator stator assembly 232 may also include such a passage or passages, or any other suitable conveyance, to provide lubricating and/or cooling oil to the region between the outer surfaces of the rotor spool 226 and the inner surfaces of the generator stator assembly 232. In addition, the generator stator assembly 232 may include a terminal housing 237 (such as that illustrated in FIG. 3(b)) which includes wires 238 extending from the outer coil assemblies 218 (such as is illustrated in FIG. 3(a)). The wires 238 of the outer coil assemblies 218 are grouped and pass into the terminal housing 237 having terminal connections 239 for providing electrical output of the generator assembly 200. In addition, the generator stator assembly 232 may include a mounting element 251 (such as that illustrated in FIG. 3(b)) suitable to secure the generator assembly 200 to a base plate or any other type of foundation.

In use, the generator assembly may operate to convert mechanical energy to electricity. For example, when the rotor assembly 50, 150, 250 is coupled to a prime mover, such as an engine, a turbine, etc., the prime mover rotates the rotor assembly 50, 150, 250. As a result, the inner magnetic disk assemblies 12, 112, 212 are rotated by the rotor assembly 50, 150, 250 relative to the inner coil assemblies 16, 116, 216. The rotating sets of inner magnetic disk assemblies 12, 112, 212 induce an electromotive force in the windings of the inner coil assemblies 16, 116, 216, which are conveyed to the respective terminal connections. The outer magnetic disk assemblies 14, 114, 214 are rotated by the rotor assembly 50, 150, 250 relative to the outer coil assemblies 18, 118, 218. The rotating sets of outer magnetic disk assemblies 14, 114, 214 induce an electromotive force in the windings of the inner coil assemblies 18, 118, 218, which are conveyed to the respective terminal connections.

FIG. 5(b) is a perspective, cross-sectional view that illustrates additional details of the generator stator assembly 232 and the inner stator 226 components of the generator assembly 200. As set forth above, the generator stator assembly 232 and the inner stator 226 stationary. The bearing assembly 224a is located at a first axial end of the inner stator 226 and supports the rotor assembly 250 at regions near to its axial end.

As illustrated in FIG. 5(b), each inner coil assembly 216 is arranged on and secured to an outer circumferential surface of the inner stator 226. A first inner coil assembly 216 is located at a first axial end of the inner stator 226, and a second inner coil assembly 216 is located at a second axial end of the inner stator 226. Additional inner coil assemblies 216 are arranged in a similar manner along the outer circumferential surface of the inner stator 226 at axial locations in between the first and second inner coil assemblies 216. Each inner coil assembly 216 is arranged at a predetermined axial space apart from an adjacent inner coil assembly 216.

Also, each outer coil assembly 218 is arranged on and secured to an inner circumferential surface of a generator stator assembly 232, such that the outer coil assemblies 218 are arranged so as to be within respective axial spaces between adjacent outer magnetic disk assemblies 214 and the magnetic elements 214a secured thereto, similar to the arrangement described above for the inner magnetic disk and coil assemblies 212, 216.

FIG. 5(b) illustrates an alternator adjusting stud 512 that extends axially through an endcap 503. In addition, FIG. 5(b) illustrates a pair of lift rings 532. FIGS. 5(c) and 5(d) illustrate side and front views, respectively, of the generator assembly 200.

FIG. 5(e) is a perspective, cross-sectional view, FIG. 5(f) is a longitudinal, cross-sectional view, and FIG. 5(g) is an end view, which illustrate additional details of the rotor assembly 250 of the generator assembly 200. As set forth above, the rotor assembly 250 rotates relative to the generator stator assembly 232 and the inner stator 226. The rotor assembly 250 is attachable at a first axial end via an input shaft 227 to, e.g., an engine, by a suitably designed coupling arrangement, e.g., a longitudinally arranged slot or notch.

As illustrated in FIG. 5(e), the generator assembly 200 includes magnetic disk assemblies 212, 214, which along with the rotor spool 220 form the rotor assembly 250. Each of the inner and outer magnetic disk assemblies 212, 214 includes inner and outer magnetic elements 212a, 214a, respectively. The rotor assembly 250 includes a plurality of inner magnetic disk assemblies 212 and a plurality of outer magnetic disk assemblies 214. Each of the inner and outer magnetic disk assemblies 212, 214 is secured in a radial arrangement to the rotor spool 220. Each inner magnetic disk assembly 212 extends radially within the rotor spool 220, while each outer magnetic disk assembly 214 extends radially outside of the rotor spool 220.

It should be noted that, while the generator assembly is shown and described above as including both inner and outer magnetic disk and coil assemblies, the generator assembly may include only one of the inner and outer magnetic disk and coil assemblies, i.e., either inner magnetic disk and coil assemblies or outer magnetic disk and coil assemblies. For example, the generator assembly may be configured so as to include only the inner magnetic disk and coil assemblies, without having outer magnetic disk and coil assemblies, such that the region of space outside of the rotor spool 20, 220 includes a different structural arrangement than shown and described above, e.g., a wheel drive. The generator assembly may include only the outer magnetic disk and coil assemblies, without having inner magnetic disk and coil assemblies, such that the region of space inside of the rotor spool 20, 220 includes a different structural arrangement than shown and described above.

As set forth above, the wires 30b of the inner coil assemblies 16 may be suitably arranged, e.g., grouped, and may pass through the passages 31 of the inner stator so as to form terminal connections 33, e.g., at a terminal plate located outside of the inner stator 26 or at any other suitable location. Likewise, the wires 38 of the outer coil assemblies 18 may be suitably arranged, e.g., grouped, and may pass through the passages 37 of the generator stator assembly 32 so as to form terminal connections 39, e.g., at a terminal plate located outside of the generator stator assembly 32 or at any other suitable location. The electrical output of the generator assembly 10 (or electrical input if the device 10 is arranged as a motor) is provided at these terminal connections 33, 39. The specific arrangement in which the wires 30b, 38 are gathered, and the specific arrangement or type of terminal connections into which the wires 30b, 38 are formed, may depend on the desired electrical characteristics of the generator assembly 10, among other factors. FIGS. 6(a) and (b) illustrate various example arrangements of the terminal connections 33, 39. For example, FIG. 6(a) illustrates a terminal connection 33, 39 that is configured as a wye connection. In order to provide such an arrangement, the wires 30b, 38 are gathered and connected to respective terminals which are arranged in conjunction with connection plates as shown in FIG. 6(a). Also, FIG. 6(b) illustrates a terminal connection 33, 39 that is configured as a delta connection. In order to provide such an arrangement, the wires 30b, 38 are gathered and connected to respective terminals which are arranged in conjunction with connection plates as shown in FIG. 6(b). It should be recognized that the wires 30b, 38 may be connected in various combinations to terminal connections, depending on, e.g., the desired electrical characteristics of the generator assembly 10.

The generator assembly may be employed in various different manners. For example, the generator assembly may be configured such that the outer magnetic disk assemblies and the outer coil assemblies are employed as a generator, while the inner magnetic disk assemblies and the inner coil assemblies are employed for different purposes, e.g., arranged as a motor, or vice versa. For example, the inner magnetic disk assemblies and the inner coil assemblies may instead be employed to start the generator assembly, to charge the battery, to power any one or more of the accessories of the generator assembly, etc. Alternatively, the generator assembly may be configured such that both the inner and outer magnetic disk assemblies and the inner and outer coil assemblies are employed as a generator, such that the inner magnetic disk assemblies and the inner coil assemblies are employed to augment the generated power of the outer magnetic disk assemblies and the outer coil assemblies. Still further, the dive may also be arranged as a very high efficiency electric motor. In the arrangement illustrated, e.g., in FIG. 2, the combination of the inner magnetic disk assemblies and the inner coil assemblies may be arranged as an alternator.

As set forth above, the generating capacity of the generator assembly may vary. For example, the generating capacity of the generator assembly may be increased or decreased by adding or subtracting the number of inner and/or outer magnetic disk assemblies and/or the number of inner and/or outer coil assemblies. While the example embodiments illustrated in the several Figures and described above have multiple inner and outer magnetic disk assemblies and multiple inner and outer coil assemblies, the generator assembly may also include one or more of any of these components.

The generator assembly may have certain advantages over conventional generators. For example, the generator assembly may provide a coreless-type construction. By having the windings of the various coil assemblies be coreless, e.g., without iron, the generator assembly hereof may avoid core losses that may be found in conventional generators. In addition, the generator assembly hereof may provide a split design which simplifies assembly, maintenance, repair, etc. For example, the clam-shell type design of the generator stator assembly 232, e.g., having an upper housing 2321 that mates with and forms a complete circumference with a lower housing 2322, may provide for the joining of the upper coil element 2181 with the lower coil element 2182 to form a full circumferential ring of coils. Since the magnetic disk assemblies rotate relative to the coil assemblies, it is generally desirable that the spacing between the coil assemblies and the magnetic disk assemblies be maintained during operation, thereby preventing contact between the magnetic disk assemblies and the coil assemblies. Having separate upper coil elements 2181 and lower coil elements 2182 that come together to form a full circumferential ring of coils, rather than having each ring of coils being inseparable, may provide easier handling, installation, etc., of the coil assemblies within the generator stator assembly 232, and may improve the stability of the coil assemblies during operation.

Also, the arrangement of coils, such as those illustrated in FIGS. 4(a) to 4(g), may provide certain advantages over conventional devices. For example, an arrangement of coils as illustrated, e.g., without overlapping turns, may provide for relatively low recirculation currents in the coils. Also, an arrangement of coils as illustrated, e.g., having parallel wire wound coils, may provide for relatively low resistance and relatively low IR losses. Furthermore, by having each of the single coils be configured such that the coil has a substantially flat cross-section when the coils of the three phases are combined, axial space taken up by the coil windings may be minimized, thereby providing the generator assembly to be more compact. Multiple winding assemblies also provide connectability, e.g., using terminal or reconnect boards, for a multitude of voltages, e.g., 480 V (3-phase), using the same generator, as opposed to conventional assemblies that are each capable of providing only a limited range of voltages. Furthermore, by having the coils configured to be separable, e.g., into upper and lower portions, the coils may be employed in a clam shell type arrangement that may provide easier handling, installation, etc. Still further, an arrangement of coils as illustrated may provide for a minimization or elimination of shorting between phases. Also, the arrangement of coils as illustrated may eliminate cogging, which is believed to be a problem associated with conventional assemblies, e.g., core DC brushless motors. Depending on the number of coils employed, there may be provided, e.g., a four-pole magnetic field using three windings, a three-pole magnetic field using two windings, etc.

The generator assembly may provide very high efficiency, e.g., greater than 98%. In addition, the generator assembly may provide a light weight and compact design. For example, the coreless design may provide a significant weight advantage over conventional generator assemblies for a given power output. Still further, the generator assembly may provide multiple levels of power generation, e.g., the inner magnetic disk and coil assemblies providing a first level (e.g., power, phase, etc.) of power generation, and the outer magnetic disk and coil assemblies providing a second level of power generation. Still further, and as set forth above, the generator assembly may provide, e.g., via the inner magnetic disk and coil assemblies, various motoring functions, e.g., an alternator, a device to start the generator assembly, a device to charge a battery, a device to provide power to any one or more accessories, etc.

The generator assembly may be used as a generator or as a motor, e.g., with equal efficiency. For example, while it is described above that an input shaft is turned in order to generate electrical power at suitable terminal connections, the arrangement may also be reversed such that electrical power provided by an external source at the terminal connections causes the input shaft to turn (and to thereby operate as an output, rather than an input, shaft). Furthermore, the generator assembly may simplify, as compared to conventional generator/motor assemblies, the structure necessary to provide this interchangeability between the generator and motor functions. Specifically, unlike in conventional generator assemblies, the use of the generator assembly hereof to function as a motor, e.g., by providing via an external source electrical power at the terminal connections so as to cause the input shaft to turn, does not require any other internal components.

Also, the 15 KW arrangement may be used as a model for a wheel motor. While the rating of the inner magnetic disk assemblies and the inner coil assemblies has been described herein as being 15 KW at, e.g., 1100 RPM, it should be understood that, with higher speeds, the output may be increased.

The generator assembly may provide scalability. For example, the inner and outer magnetic disk elements may be removably secured to their respective faces of the inner and outer magnetic disk assemblies. In such an arrangement, removing certain inner and/or outer magnetic disk elements from their respective faces of the inner and outer magnetic disk assemblies may provide the power output to be decreased as desired. Likewise, replacing certain inner and/or outer magnetic disk elements with inner and/or outer magnetic disk elements of a smaller size may also provide the power output to be decreased as desired. Similarly, increasing the number of inner and/or outer magnetic disk elements that are secured to respective faces of the inner and outer magnetic disk assemblies may provide the power output to be increased as desired. Still further, replacing certain inner and/or outer magnetic disk elements with inner and/or outer magnetic disk elements of a larger size may also provide the power output to be increased as desired.

The generator assembly may provide, with the use of a single generator assembly, the use of, and generation of, multiple frequencies and/or outputs independent of the RPM (rotations-per-minute) at which the generator assembly is operated.

The generator assembly may be employed in connection with various applications, e.g., any application in which electric energy is converted to kinetic energy, or in which kinetic energy is converted to electric energy. For example, applications may include, without being limited to, land based transportation, marine propulsion, aircraft applications, home appliances, the driving of field- or factory-type machinery, etc. The following are several examples in which the generator assembly may be employed.

For example, the generator assembly may be employed in automotive/truck alternator applications. Automotive/small truck alternators are typically sized to produce about 45 ampere-hours (AH) at approximately 14 volts of output to maintain starting/operating batteries. Special purpose alternators of substantially the same size can be purchased as replacement units up to about 150 AH. The generator assembly hereof may be employed as, e.g., an alternator replacement, which at comparable sizes may increase the output to about 250 AH.

In the automotive industry, systems may employ a 42-volt DC system, and may drive auxiliary systems such as power steering, power brakes, A/C, water pumps, etc., with electric power instead of by engine power direct or belt drive. Such an arrangement may provide improved efficiency, because the actual energy used may be tailored by control computers to that needed for the function on a moment-to-moment basis. A significant weight reduction may also be achieved by such an arrangement, further increasing automobile performance and efficiency (e.g., miles per gallon).

The generator assembly may be employed in applications that use small motors (e.g., ½ hp to 5 hp) and medium size (e.g., 5 hp to 25 hp) electric motors. Conventionally, induction motors are employed for such applications. However, induction motors are believed to have the disadvantage in that they have a field winding to build and maintain the magnetic field for the motor to produce kinetic energy. Thus, there is a large inrush current to start the motor. For example, a typical refrigeration motor may require, e.g., 18 amps to start it, but only 3 amps once it is running. Also, induction motors have low power factors (e.g., energy efficiency). For example, induction motors have a power factor as low as, e.g., 0.75, in smaller units to as high as, e.g., 0.92, in other units. The motor assembly hereof may provide no large inrush of current during initial starting and may provide a power factor of, e.g., better than 0.95.

The assembly may be employed in applications that use small, e.g., specialized, electric motors. The electric motor may be designed so as to be integral within a larger component. For example, the assembly may be employed as a small special purpose electric motor which is designed for, and built into, a predetermined application. For example, the electric motor may be integral in a compressor unit of, e.g., a refrigeration/air conditioning compressor unit, which are typically in the, e.g., ½ hp to 5 hp range. Because applications such as these are so numerous and have a major effect on franchised utility power production, transmission and distribution, energy efficiency requirements are, in certain jurisdictions, mandated by law. The assembly hereof may better conform to energy efficiency standards, such as higher federal energy efficiency standards that are currently being mandated in the U.S.A. in 2008 and again in 2010.

When arranged as a generator, the assembly hereof may provide that full and immediate power is provided from the initiation of start-up. Moreover, when arranged as a motor, the assembly hereof may provide that full and immediate torque is provided from the initiation of start-up.

What is claimed is:

1. A generator, comprising:
a radially-inner stator including at least one radially-inner coil;
a radially-outer stator including at least one radially-outer coil; and
a rotor assembly arranged radially between the inner stator and the outer stator, the rotor rotatable relative to the inner stator and the outer stator, the rotor assembly including at least one radially-outer magnetic element adjacent to the outer coil and including at least one radially-inner magnetic element adjacent to the inner coil.

2. The generator according to claim 1, wherein the rotor assembly is attached to an input shaft.

3. The generator according to claim 1, wherein each outer coil is arranged in space between outer magnetic elements, and each inner coil is arranged in space between inner magnetic elements.

4. The generator according to claim 3, wherein the rotor assembly includes a rotor spool, each outer magnetic element secured to and extending radially outwardly from an outer circumferential surface of the rotor spool.

5. The generator according to claim 4, wherein each outer coil is secured to and extends radially inwardly from an inner circumferential surface of the outer stator.

6. The generator according to claim 3, wherein the rotor assembly includes a rotor spool, each inner magnetic element secured to and extend radially inwardly from an inner circumferential surface of the rotor spool.

7. The generator according to claim 6, wherein each inner coil is secured to and extends radially outwardly from an outer circumferential surface of the inner stator.

8. The generator according to claim 1, wherein the rotor assembly is supported relative to at least one of (a) the outer stator and (b) the inner stator by bearing assemblies.

9. The generator according to claim 1, wherein at least one of (a) the outer stator and (b) the inner stator includes a passage adapted to convey a lubrication medium.

10. The generator according to claim 1, wherein at least one of (a) the outer stator and (b) the inner stator includes a terminal connection and a passage, wires from the coils extending through the passage to the terminal connection.

11. The generator according to claim 1, wherein the outer magnetic elements and the outer coils are arranged for generation of electricity and the inner magnetic elements and the inner coils are not arranged for generation of electricity.

12. The generator according to claim 1, wherein a first one of (a) the outer magnetic elements and the outer coils and (b) the inner magnetic elements and the inner coils are arranged for generation of electricity and a second one of (a) the outer magnetic elements and the outer coils and (b) the inner magnetic elements and the inner coils are arranged as a motor.

13. A device, comprising:
a radially-inner stator including at least one radially-inner coil;
a radially-outer stator including at least one radially-outer coil; and
a rotor assembly arranged radially between the inner stator and the outer stator, the rotor rotatable relative to the inner stator and the outer stator, the rotor assembly including at least one radially-outer magnetic element adjacent to the outer coil and including at least one radially-inner magnetic element adjacent to the inner coil;
wherein the inner magnetic elements and the inner coils are arranged as at least one of (a) a generator and (b) a motor; and
wherein the outer magnetic elements and the outer coils are arranged as at least one of (a) a generator and (b) a motor.

14. A motor, comprising:
a radially-inner stator including at least one radially-inner coil;
a radially-outer stator including at least one radially-outer coil;
a rotor assembly arranged radially between the inner stator and the outer stator, the rotor assembly rotatable relative to the inner stator and the outer stator, the rotor assembly including at least one radially-outer magnetic element adjacent to the outer coil and at least one radially-inner magnetic element adjacent to the inner coil.

15. The motor according to claim 14, wherein the rotor assembly is attached to an output shaft.

16. The motor according to claim 14, wherein each outer coil is arranged in space between outer magnetic elements and each inner coil is arranged in space between inner magnetic elements.

17. The motor according to claim 16, wherein the rotor assembly includes a rotor spool, each outer magnetic element are secured to and extending radially outwardly from an outer circumferential surface of the rotor spool.

18. The motor according to claim 17, wherein each outer coil is secured to and extends radially inwardly from an inner circumferential surface of the outer stator.

19. The motor according to claim 16, wherein the rotor assembly includes a rotor spool, each inner magnetic element secured to and extending radially inwardly from an inner circumferential surface of the rotor spool.

20. The motor according to claim 19, wherein each inner coil is secured to and extends radially outwardly from an outer circumferential surface of the inner stator.

21. The motor according to claim 14, wherein the rotor assembly is supported relative to at least one of (a) the outer stator and (b) the inner stator by bearing assemblies.

22. A generator, comprising:
a stator including at least one coil, the at least one coil being secured to and extending radially inwardly from an inner circumferential surface of the stator; and
a rotor assembly arranged radially inward relative to the stator, the rotor rotatable relative to the stator, the rotor assembly including magnetic elements secured to and extending radially outwardly from the rotor assembly such that each coil is arranged in space between the magnetic elements.

23. The generator according to claim 22, wherein the rotor assembly is attached to an input shaft.

24. The generator according to claim 22, wherein the rotor assembly is supported relative to the stator by bearing assemblies.

25. The generator according to claim 22, wherein the stator includes a passage adapted to convey a lubrication medium.

26. The generator according to claim 22, wherein the stator includes a terminal connection and a passage, wires from the coils extending through the passage to the terminal connection.

27. The generator according to claim 22, wherein the magnetic elements and the coils are arranged for generation of electricity.

28. A generator, comprising:
a stator including at least one coil, the at least one coil being secured to and extending radially outwardly from an outer circumferential surface of the stator; and
a rotor assembly arranged radially outward relative to the stator, the rotor rotatable relative to the stator, the rotor assembly including magnetic elements secured to and extending radially inwardly from the rotor assembly such that each coil is arranged in space between the magnetic elements.

29. The generator according to claim 28, wherein the rotor assembly is attached to an input shaft.

30. The generator according to claim 28, wherein the rotor assembly is supported relative to the stator by bearing assemblies.

31. The generator according to claim 28, wherein the stator includes a passage adapted to convey a lubrication medium.

32. The generator according to claim 28, wherein the stator includes a terminal connection and a passage, wires from the coils extending through the passage to the terminal connection.

33. The generator according to claim 28, wherein the magnetic elements and the coils are arranged for generation of electricity.

34. A coil arrangement for at least one of (a) a generator and (b) a motor, comprising:
a plurality of windings arranged substantially in a single plane, each winding including:
a first circumferential portion following a substantially arcuate path;
a first radial portion extending radially inwardly from a first end of the first circumferential portion;
an intermediate portion, a first end of the intermediate portion arranged at a radially inward end of the first radial portion;
a second radial portion extending radially outwardly from a second end of the intermediate portion; and
a second circumferential portion following a substantially arcuate path, a first end of the second circumferential portion arranged at a radially outward end of the second radial portion.

35. The coil arrangement according to claim 34, wherein the first circumferential portion of each winding is connected to the second circumferential portion of a circumferentially adjacent winding.

36. The coil arrangement according to claim 34, wherein the windings include at least (a) a first subset of windings corresponding to a first phase and (b) a second subset of windings corresponding to a second phase.

37. The coil arrangement according to claim 34, wherein the windings include (a) a first subset of windings corresponding to a first phase, (b) a second subset of windings corresponding to a second phase and (c) a third subset of winding corresponding to a third phase.

38. The coil arrangement according to claim 34, wherein each winding includes a plurality of conductors.

39. The coil arrangement according to claim 34, wherein the windings are arranged circumferentially about a substrate, the substrate one of (a) circular and (b) semi-circular.

40. A generator, comprising:
a radially-outer stator including at least one radially-outer coil; and
a rotor assembly arranged radially within the outer stator, the rotor rotatable relative to the outer stator, the rotor assembly including at least one radially-outer magnetic element adjacent to the outer coil,
wherein the radially-outer stator is separable into first and second portions.

41. The generator according to claim 40, further comprising a radially-outer stator including at least one radially-outer coil, wherein the rotor assembly is arranged radially between the inner stator and the outer stator, the rotor rotatable relative to the inner stator, the rotor assembly also including at least one radially-inner magnetic element adjacent to the inner coil.

42. The generator according to claim 40, wherein the rotor assembly is attached to an input shaft.

43. The generator according to claim 41, wherein each outer coil is arranged in space between outer magnetic elements, and each inner coil is arranged in space between inner magnetic elements.

44. The generator according to claim 43, wherein the rotor assembly includes a rotor spool, each outer magnetic element secured to and extending radially outwardly from an outer circumferential surface of the rotor spool.

45. The generator according to claim 44, wherein each outer coil is secured to and extends radially inwardly from an inner circumferential surface of the outer stator.

46. The generator according to claim 43, wherein the rotor assembly includes a rotor spool, each inner magnetic element secured to and extending radially inwardly from an inner circumferential surface of the rotor spool.

47. The generator according to claim 46, wherein each inner coil is secured to and extends radially outwardly from an outer circumferential surface of the inner stator.

48. The generator according to claim 41, wherein the rotor assembly is supported relative to at least one of (a) the outer stator and (b) the inner stator by bearing assemblies.

49. The generator according to claim 41, wherein at least one of (a) the outer stator and (b) the inner stator includes a passage adapted to convey a lubrication medium.

50. The generator according to claim 40, wherein at least one of (a) the outer stator and (b) the inner stator includes a terminal connection and a passage, wires from the coils extending through the passage to the terminal connection.

51. The generator according to claim 41, wherein the outer magnetic elements and the outer coils are arranged for generation of electricity and the inner magnetic elements and the inner coils are not arranged for generation of electricity.

52. The generator according to claim 41, wherein a first one of (a) the outer magnetic elements and the outer coils and (b) the inner magnetic elements and the inner coils are arranged for generation of electricity and a second one of (a) the outer magnetic elements and the outer coils and (b) the inner magnetic elements and the inner coils are arranged as a motor.

53. A coil arrangement for at least one of (a) a generator and (b) a motor, comprising:
a plurality of windings, each winding including:
circumferential portions that follow a substantially arcuate path;
radial portions that extend radially inwardly relative to the circumferential portions;
wherein the radial portions of a first subset of windings alternate circumferentially with the radial portions of a second subset of windings, and wherein the circumferential portions of the first subset of windings are superposed with the circumferential portions of the second subset of windings, such that, in operation, the first and second subsets of windings are arranged substantially in a single plane.

54. The coil arrangement according to claim 53, further comprising a third subset of windings, wherein the radial portions of a first, second and third subsets of windings alternate circumferentially relative to each other, and wherein the circumferential portions of the first, second and third subsets of windings are superposed relative to each other, such that, in operation, the first, second and third subsets of windings are arranged substantially in a single plane.

55. The coil arrangement according to claim 53, wherein each winding is formed of two semi-circular winding portions that are connectable so as to form a full circumferential arrangement.

56. The coil arrangement according to claim 55, wherein each one of the two semi-circular winding portions are configured to fit within a respective portion of a clamshell-type outer stator assembly.

57. The coil arrangement according to claim 56, wherein each one of the windings have respective wires that extend to a terminal connection.

58. The coil arrangement according to claim 57, wherein the wires are arranged at the terminal connection so as to provide a wye connection.

59. The coil arrangement according to claim 57, wherein the wires are arranged at the terminal connection so as to provide a delta connection.
